(19) United States
(12) Patent Application Publication
(10) Pub. No.: US 2021/0053417 A1
(43) Pub. Date: Feb. 25, 2021

(54) AIR CONDITIONING SYSTEM FOR A VEHICLE AND VEHICLE WITH AN AIR CONDITIONING SYSTEM

(71) Applicant: MOTHERSON INNOVATIONS COMPANY LIMITED, London (GB)

(72) Inventors: Urszula Kosidlo, Stuttgart (DE); Iain Fleming, London (GB)

(21) Appl. No.: 16/964,677

(22) PCT Filed: Jan. 22, 2019
(86) PCT No.: PCT/EP2019/051493

§ 371 Date: Jul. 24, 2020

(30) Foreign Application Priority Data
Jan. 26, 2018 (DE) 10 2018 101 859.2

(51) Int. Cl. B60H 1/00; B60H 1/22

(52) U.S. Cl. CPC B60H 1/00392; B60H 2001/003; B60H 1/2227; B60H 1/00295

(57) ABSTRACT

The invention relates to an air conditioning system for a vehicle, in particular an electric vehicle, comprising at least one active heating and/or cooling device, at least one passive heating and/or cooling device, and a control unit for controlling the at least one active and the at least one passive heating and/or cooling device, wherein
the at least one active and the at least one passive heating and/or cooling device each comprises a nanomaterial,
the at least one passive heating and/or cooling device comprises a thermal conductor element, which is thermally coupling at least one electronic device, in particular a display, to an outside air stream,
the at least one active heating and/or cooling device comprises a nanoparticle containing resistive heating element for actively heating and/or the nanomaterial of the at least one cooling device is brought into contact with a cooling fluid in addition to an outside air stream for actively cooling, and
the control unit is adapted to control the at least one active and the at least one passive heating and/or cooling device depending on an input from at least one sensor, in particular a temperature sensor, and/or depending on at least one user input.

The invention further relates to a vehicle with such an air conditioning system (10).

### BACKGROUND

### 1. Field of the Invention

The invention relates to an air conditioning system for a vehicle, in particular an electrical vehicle, as well as to a vehicle with such an air conditioning system.

### 2. Related Art

While in conventional, combustion engine driven vehicles the engine's waste heat is sufficient to provide all heating needs of the vehicle, electrically driven vehicles face particular problems with regard to heating and cooling. In particular, the waste heat of electric engines is often not sufficient to provide the necessary heating for the vehicle's interior during cold days. Moreover, the increasing number of electronic components in such vehicles, in particular displays and the like, pose an additional waste heat problem. The waste heat has to be removed from such components to prevent overheating, but is usually not readily usable for any other purpose and thus radiated into the environment. Thus, to provide heating and cooling for an electrical vehicle, active means are necessary, which drain the vehicle's battery and consequently reduce its range.

Vehicular radiators and other heat exchangers containing carbon nanotubes (CNTs) are described in US 2017/0211899 A1. The known nanotube heat exchanger can include a coolant flow passage, an airflow path, a heat exchanger core bounding at least a portion of the coolant flow passage and the airflow path. The heat exchanger core contains a plurality of CNTs configured to enhance heat transfer from a coolant conducted through the coolant flow passage to airflow directed along the airflow path during operation of the nanotube heat exchanger. The CNTs can be, for example, single walled CNTs or other CNTs incorporated into one or more regions of the heat exchanger core by applying a nanotube coating to selected surfaces of the heat exchanger core or by producing the heat exchanger core to include one or more sintered, CNT-containing components.

A heated covering element for a motor vehicle with a vehicle base and with a passenger compartment comprising at least two lining components, namely a carrier element for attachment to the vehicle base and a decorative element for the design of the passenger compartment, is known from DE 102015 220 253 A1, wherein a surface of one of the lining components has a coating such that the coating forms an electrical heating element, by means of which heat is selectively generated in a current transmission and delivered to the coated cladding component.

A vehicle with a heat source, a heat sink and a heat pipe, which communicates with the heat source and the heat sink, is described in DE 10 2009 049 196 A1, wherein the heat pipe has a control element with which the heat flow from the heat source to the heat sink can be controlled.

U.S. Pat. No. 7,213,637 B2 refers to a heat operating fluid for a heat pipe, the operating fluid comprising a liquid and a plurality of nanometer-scale particles suspended in the liquid.

DE 10 2016 110 971 A1 discloses an engine cooling system for a motor vehicle engine of a motor vehicle, comprising a heat-generating engine block, a heat pipe thermally coupled directly to the engine block for dissipating the heat, and an air conditioner for controlling the temperature of a passenger compartment of the motor vehicle, wherein the air conditioner has an air duct for supplying air into the passenger compartment and the heat pipe for temperature control of the air projects into the air duct.

### SUMMARY

It is the technical problem underlying the present invention to provide an air conditioning system for a vehicle, in particular and electric vehicle, which is particularly energy efficient and makes maximum use of the available heat sources as well as of the available cooling opportunities.

This problem is solved by an air conditioning system for a vehicle, in particular an electric vehicle, comprising at least one active heating and/or cooling device, at least one passive heating and/or cooling device, and a control unit for controlling the at least one active and the at least one passive heating and/or cooling device, wherein
the at least one active and the at least one passive heating and/or cooling device each comprises a nanomaterial,
the at least one passive heating and/or cooling device comprises a thermal conductor element, which is thermally coupling at least one electronic device, in particular a display, to an outside air stream,
the at least one active heating and/or cooling device comprises a nanoparticle containing resistive heating element for actively heating and/or the nanomaterial of the at least one cooling device is brought into contact with a cooling fluid in addition to an outside air stream for actively cooling, and
the control unit is adapted to control the at least one active and the at least one passive heating and/or cooling device depending on an input from at least one sensor, in particular a temperature sensor, and/or depending on at least one user input.

It is the astonishing perception of the invention to provide a combined system of passive and active material that can be both used for heating and cooling. The usage of the control unit allows for efficient control of the vehicle's interior temperature.

By using the sensor, the temperature in the vehicle's interior can be automatically controlled without the need of additional user inputs. In a manual mode, the interior environment of the vehicle can be controlled exactly to the desires of the user. It is preferred that the control unit is readily switchable between the described automatic and manual modes.

Nanomaterials are known for excellent thermal conductivity properties, so that the efficiency of such active and passive heating and/or cooling devices is particularly good. This improves the total energy efficiency of the air conditioning system.

Waste heat from the electronic device can be easily removed from the device according to the invention, thus avoiding overheating. Moreover, by the use of a passive thermal conductor element, no active cooling measures, such as fans or compression cooling machines are necessary to keep the electronic devices at their desired working temperature.

According to the invention it is preferred that the nanomaterial is a composite material, preferably within a matrix, in particular a polymer matrix, and/or the nanomaterial comprises carbon nanoparticles, in particular carbon nanotubes, carbon black, carbon nanohorns, graphite, graphene and/or graphene nanoplatelets, and/or inorganic nanoparticles, in particular nanosilver, aluminum oxide, copper oxide, titanium oxide, beryllium oxide, boron nitride and/or aluminum nitride. The passive heating and/or cooling device can comprise the composite nanomaterial, preferably based on plastic and containing carbon nanotubes, and/or preferably as bulk or as coating.

All the listed nanomaterials exhibit the desired high thermal conductivity properties. Moreover, by embedding such nanoparticles into a polymer matrix, the resulting nanomaterial can be manufactured and formed by standard methods, such as injection molding. Consequently, the use of such materials does not require expensive re-gearing or the design of entirely new tools, making the manufacturing of such an air conditioning system particularly cost effective.

With the invention it is also proposed that the thermal conductor element is thermally coupled to the outside air stream via a further active heating and/or cooling device, in particular a heat exchanger.

The heat exchanger itself also contains nanomaterials of the described sort, making it particularly effective.

It is preferred to use an air flow directing device for alternatively directing the outside air stream into an interior space of the vehicle or into the environment of the vehicle.

In this manner, the waste heat directed to the outside air stream can either be used for heating the interior of the vehicle on cold days or can easily be dissipated to the outside on warm days, thus reducing the need for additional active heating or cooling of the interior of the vehicle depending on environmental conditions.

In a further preferred embodiment of the invention, the resistive heating element is integrated into a coating and/or textile and/or interior element of the vehicle.

This alleviates the need for additional heating devices within interior components of the vehicle, which increase the vehicles weight and take up valuable room.

In a further preferred embodiment of the invention, the resistive heating element is integrated into a cockpit element, door element, floor mat, seat, window coating, roof window and/or roof lining of the vehicle.

This allows for the application of heat at the desired spots within the vehicle's interior without the need for additional heating devices such as seat heaters, window heaters or the like.

In a further preferred embodiment of the invention, the at least one passive cooling device is a nanoparticle containing coating, in particular a roof coating and/or a window coating.

In addition to the aforementioned excellent thermal conductivity properties, nanomaterials of the described kind also provide excellent reflectivity, in particular in the infrared range. Such a coating can thus prevent excessive heating of the vehicle in particular under intensive solar irradiation. This reduces the need for active cooling of the vehicle's interior.

In a further preferred embodiment of the invention, the at least one active and the at least one passive heating and/or cooling device further comprises a phase change material.

Phase change materials possess a particularly high thermal capacity, which improves the heating and/or cooling efficiency of such a device.

It is proposed by the invention that the active heating device is activated via the input of an external stimuli, preferably in form of an electrical signal and/or applied via electrodes.

Thus, the nanoparticle containing material can be contacted via electrodes. Upon application of an electrical voltage, the nanomaterial heats up and releases heat into the environment. Such heating elements are particularly effective and compact, thus reducing electricity consumption and waste

The invention further relates to a vehicle with an air conditioning system as described above.

The advantages explained earlier also come to bear in this case.

### BRIEF DESCRIPTION OF THE DRAWINGS

In the following, the invention and its embodiments is explained in detail with reference to the drawing which shows in

FIG. 1 is a schematic representation of an embodiment of an air conditioning system according to the invention.

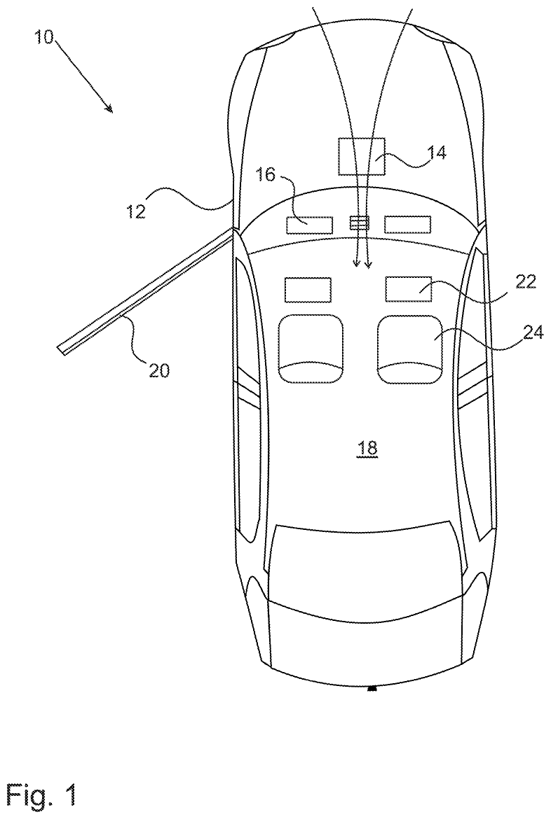

### DETAILED DESCRIPTION

An air conditioning system 10 for a vehicle 12 comprises according to the invention at least one heat exchanger 14, which is coupled to an outside airflow.

The heat exchanger 14 comprises at least one nanomaterial, in particular a composite material containing carbon nanoparticles or inorganic nanoparticles embedded in a polymer matrix. Such nanomaterials have a particularly high thermal conductivity, thus providing a very effective heat exchanger 14. The heat exchanger 14 is thermally coupled to electronic devices 16, for example displays of the vehicle 12.

The thermal coupling between the heat exchanger 14 and the electronic devices 16 can be performed by further nanomaterial containing units, for example thermal conductors or heat pipes or the like, so that the waste heat of the electronic devices is transferred to the outside air stream in a particularly efficient manner.

It is further advantageous if the outside air stream can alternatively be directed into an interior space 18 of the vehicle 12 or back into the outside environment. In this manner, the waste heat of the electronic devices 16 can be used to heat the interior 18 on cold days, or alternatively to remove excess heat from the vehicle 12 to the environment on warm days.

The air conditioning system of the invention further comprises resistive heating devices. These are also based on the above-mentioned nanomaterials and contain additional electrodes in order to provide the nanomaterials with an electric potential, resulting in the nanomaterials heating up.

Such resistive heating devices can be integrated into various internal components of the vehicle 12, for example in door linings 20, floor mats 22, the textile coverings or the internal stuffings of seats 24, cockpit coverings, window coating or roof lining of the vehicle 12.

This reduces the need for additional, bulky and energy intensive active heaters, so that the vehicle 12 is particularly light and energy efficient.

The air conditioning system 10 can further comprise passive nanomaterial coatings, in particular roof coatings or window coatings. In addition to the aforementioned excellent thermal conductivity, such nanomaterials also have a high reflectivity, in particular in the infrared spectral range. By means of such coatings, incident sunlight can be reflected efficiently from the vehicle 12, thus reducing the heating of the vehicle under direct solar irradiation. This reduces the need for active cooling means, which are a particularly high strain on the battery of electric vehicles.

All described heating or cooling devices can further comprise additional phase change materials, which increase their thermal capacity and thus their efficiency.

In summary, a particularly light and energy efficient air conditioning system 10 is provided, in form of a combined system of passive and active materials which is particularly advantageous for the use in electric vehicles.

The features disclosed in the claims, the specification, and the drawings maybe essential for different embodiments of the claimed invention, both separately or in any combination with each other.

### REFERENCE SIGN LIST

10 air conditioning system
12 vehicle
14 heat exchanger
16 electronic device
18 interior space
20 door linings
22 floor mats
24 seat

1-11. (canceled)

12. An air conditioning system for a vehicle or an electric vehicle, comprising:
at least one of an active heating or cooling device;
at least one of a passive heating or cooling device; and
a control unit for controlling the at least one of active heating or cooling device and the at least one of passive heating and cooling device, wherein
the at least one active and the at least one passive heating or cooling device each comprises a nanomaterial,
the at least one passive heating or cooling device comprises a thermal conductor element, which is thermally coupling at least one electronic device or a display to an outside air stream,
the at least one active heating or cooling device comprises a nanoparticle containing resistive heating element for actively heating, or the nanomaterial of the at least one active cooling device is brought into contact with a cooling fluid in addition to an outside air stream for actively cooling, and
the control unit is adapted to control the at least one active heating or cooling device depending on an input from at least one sensor or a temperature sensor.

13. The air conditioning system according to claim 12, wherein at least one of:
the nanomaterial is a composite material, within a matrix or a polymer matrix, or
the nanomaterial comprises at least one of carbon nanoparticles or carbon nanotubes, carbon black, carbon nanohorns, graphite, one or more of graphene or graphene nanoplatelets, or inorganic nanoparticles or nanosilver, aluminum oxide, copper oxide, titanium oxide, beryllium oxide, boron nitride, or aluminum nitride.

14. The air conditioning system according to claim 12, wherein the at least one of passive heating or cooling device comprises the composite nanomaterial, preferably based on plastic and containing carbon nanotubes, or preferably as bulk or as coating.

15. The air conditioning system according to claim 12, wherein the thermal conductor element is thermally coupled to the outside air stream via a further at least one of active heating or cooling device or a heat exchanger.

16. The air conditioning system according to claim 12, further comprising an air flow directing device for alternatively directing the outside air stream into an interior space of the vehicle or into an environment of the vehicle.

17. The air conditioning system according to claim 12, wherein the resistive heating element is integrated into one or more of a coating, textile, or interior element of the vehicle.

18. The air conditioning system according to claim 17, wherein the resistive heating element is integrated into a cockpit element, door element, floor mat, seat, window coating, roof window, or roof lining.

19. The air conditioning system according to claim 12, wherein the at least one passive cooling device is a nanoparticle containing coating, a roof coating, or a window coating.

20. The air conditioning system according to claim 12, wherein the at least one active and the at least one passive heating or cooling device further comprises a phase change material.

21. The air conditioning system according to claim 12, wherein the active heating device is activated via an input of an external stimuli, in form of one or more of an electrical signal or applied via electrodes.

22. A vehicle comprising an air conditioning system, comprising:
at least one of an active heating or cooling device;
at least one of a passive heating or cooling device; and
a control unit for controlling the at least one of active heating or cooling device and the at least one of passive heating and cooling device, wherein
the at least one active and the at least one passive heating or cooling device each comprises a nanomaterial,
the at least one passive heating or cooling device comprises a thermal conductor element, which is thermally coupling at least one electronic device or a display to an outside air stream,
the at least one active heating or cooling device comprises a nanoparticle containing resistive heating element for actively heating, or the nanomaterial of the at least one active cooling device is brought into contact with a cooling fluid in addition to an outside air stream for actively cooling, and
the control unit is adapted to control the at least one active heating or cooling device depending on an input from at least one sensor or a temperature sensor, and the control unit is adapted.
